(19) United States
(12) Patent Application Publication
(10) Pub. No.: US 2007/0039764 A1
(43) Pub. Date: Feb. 22, 2007

(54) Systems and methods for harnessing wind power to power an automobile

(76) Inventor: Nathan Truett McBryde, Austin, TX (US)

Correspondence Address: PATRICK STELLITANO, 2803 INRIDGE DR., AUSTIN, TX, 78745, US

(21) Appl. No.: 11/208,040

(22) Filed: Aug. 19, 2005

(51) Int. Cl. B60K 16/00

(52) U.S. Cl. 180/2.2

(57) ABSTRACT

Systems and methods for harnessing wind power to power a vehicle are disclosed. Wind passing the vehicle is captured by a fly wheel that converts the wind power to rotational power. The rotational power applies to drive a fluid pump. The fluid is pumped through a receiver pump to drive a shaft of the vehicle.

### FIELD

The present invention is in the field of wind power. In particular, the invention is in the field of harnessing wind power to supplement the power of an engine of an automobile to improve fuel efficiency.

### SUMMARY

The problems of improving fuel efficiency of a vehicle are in large part addressed by an apparatus and method to harness wind power to supplement the power provided by an engine to move a vehicle such as a car or truck. One embodiment comprises an air scoop for capturing wind flowing passed the vehicle. A flywheel captures air in the air scoop causing rotation of the flywheel. A fluid pump rotates by rotation of the flywheel and pumps fluid. A receiver pump receives fluid pumped by the fluid pump. The received fluid rotates the receiver pump. A connecting mechanism connects to a shaft of the vehicle and connects to the receiver pump to transfer rotation of the receiver pump to rotation of the shaft.

Another embodiment is a method for harnessing wind power to supplement the power of an engine in a moving vehicle, comprising: converting air passing the vehicle from linear to rotational power; applying the rotational power to a fluid pump to pump fluid; applying the pumped fluid to a receiver pump to create a rotational force; and applying the rotational force to drive the vehicle.

Another embodiment is a wind-powered vehicle, comprising an engine to provide a principle source of power to the vehicle. An air capturing mechanism converts wind power to rotational power of a first shaft. A fluid pump attaches to rotate by rotation of the first shaft. A receiver pump receives fluid pumped by the fluid pump and rotates in response thereto. A second shaft rotates by rotation of the receiver pump.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a side view of an embodiment attached to a vehicle for capturing and converting wind power to power the vehicle.

FIG. 2 depicts a top view of an embodiment attached to a vehicle for capturing and converting wind power to power the vehicle.

FIG. 3 depicts a flywheel, generator and fluid pump.

FIG. 4 depicts a receiver pump to drive a shaft of the vehicle.

FIG. 5 depicts a receiver pump for delivering rotational force to a shaft.

FIG. 6 depicts an air fan to deliver rotational power to a shaft of the vehicle.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems and methods for harnessing wind power to power a vehicle are disclosed. Wind passing the vehicle is captured by a fly wheel that converts the wind power to rotational power. The rotational power applies to drive a fluid pump. The fluid is pumped through a receiver pump to drive a shaft of the vehicle.

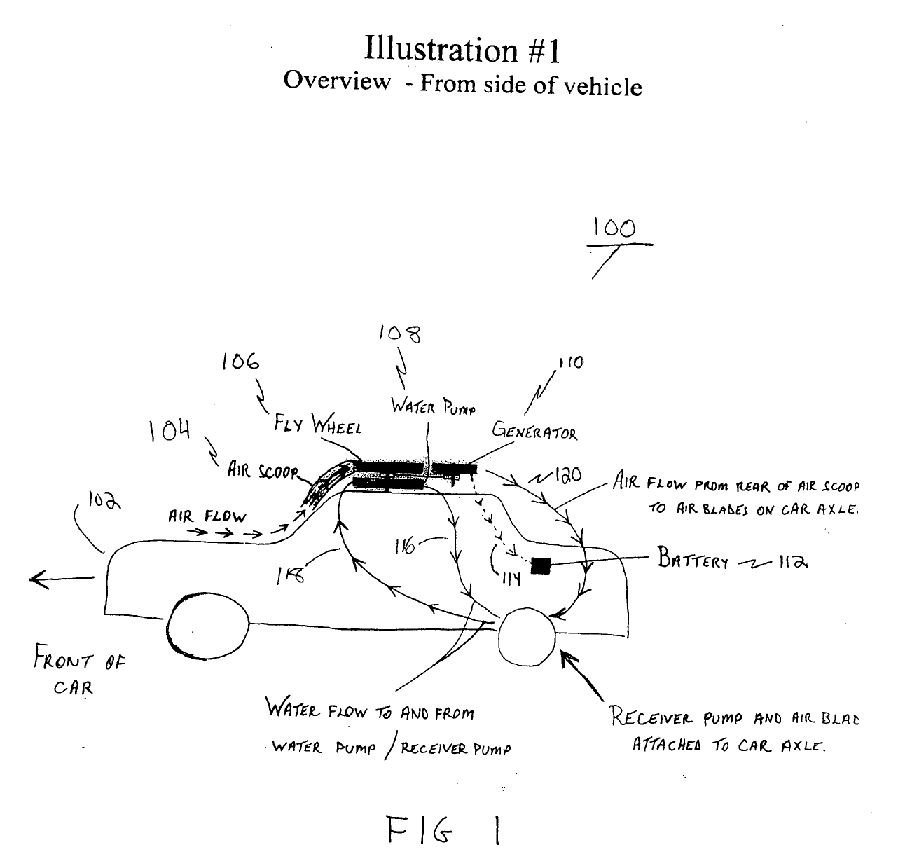

FIG. 1 shows an embodiment 100 for harnessing wind power to power a vehicle such as a car or truck. When the vehicle 102 is in motion, powered in part, by a standard engine, such as a gasoline or diesel powered engine, air flows along the surface of the hood, up along the surface of the front windshield, and to the top of the vehicle. An air scoop 104 is positioned to capture air flowing to the top of the vehicle. Air scoop 104 channels air to an air-capturing fly wheel 106. Fly wheel 106 is mounted on a shaft with a water pump 108. Fly wheel 106 is connected by a belt to a generator 110. Generator 110 provides electrical power to a battery 112 through electrical wiring 114. Water pump 108 pumps water to a receiver pump (not shown in FIG. 1). The water in the receiver pump is circulated through hoses 116 and 118 to and from the receiver pump. In one embodiment, the receiver pump is mounted on a shaft that turns with the wheel axle of the vehicle. In another embodiment, the receiver pump is mounted on a shaft that turns with the primary drive axle of the vehicle. Another hose 120 channels air exiting from fly wheel 106 to air-capturing blades of the receiver pump. Also, in the alternative to water pump 108, a hydraulic fluid pump can be implemented with hydraulic fluid-carrying hoses 116 and 118.

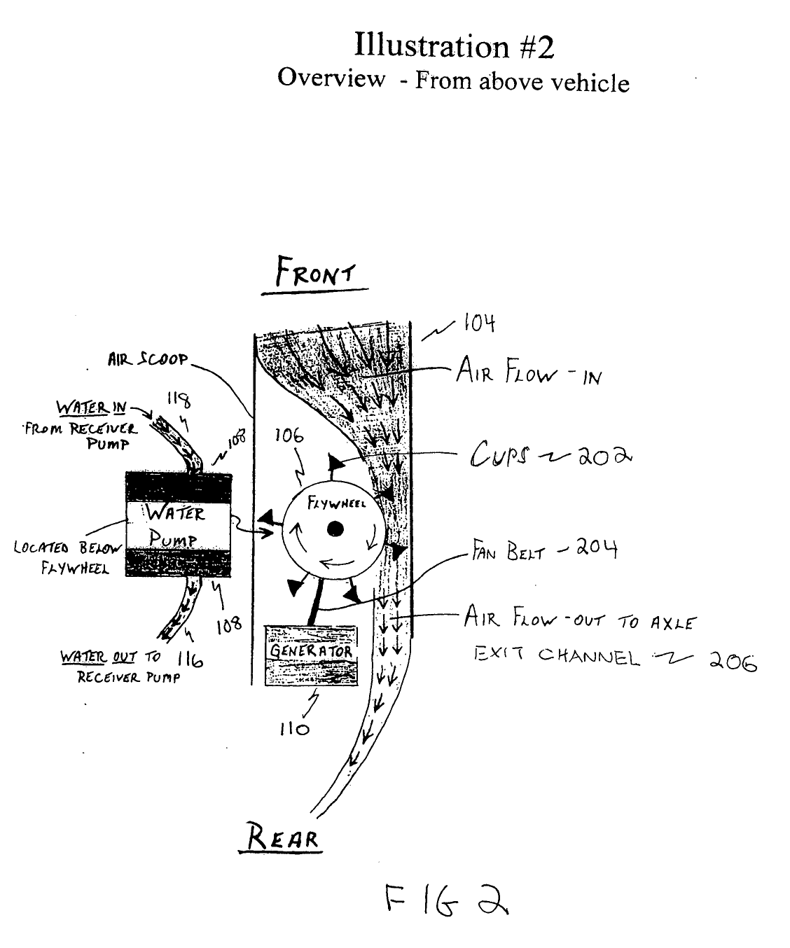

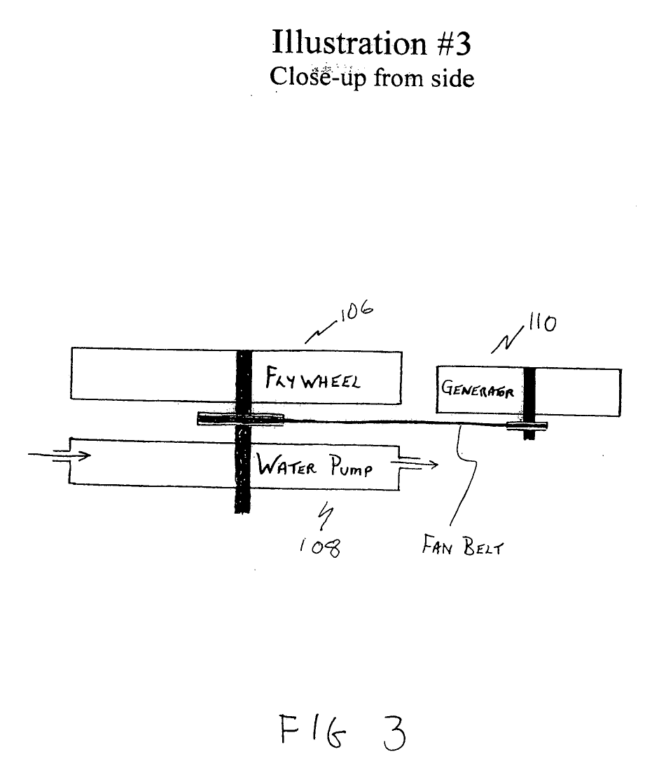

FIG. 2 shows a top view of an embodiment for harnessing wind power to power a vehicle. FIG. 3 shows a close up side view of flywheel 106 connected by a belt to generator 110 and connected by a shaft to fluid pump 108. Air flows in from air scoop 104 and is captured by blades or cups 202 attached to fly wheel 106. Air flow captured by cups 202 cause fly wheel 106 to rotate about the axis of a shaft upon which fly wheel 106 is mounted. Located below fly wheel 106 is a water pump or air compressor or hydraulic fluid pump 108, hereafter, a fluid pump. In one embodiment, fluid pump 108 is mounted on the same shaft as fly wheel 106. In another embodiment, fluid pump 108 is connected by a belt to fly wheel 106. In yet another embodiment, fluid pump 108 is connected by a gear to fly wheel 106. In one embodiment, fluid pump 108 pumps fluid to a receiver pump mounted on an axle or drive shaft of the vehicle. In another embodiment, fluid pump 108 is a fluid compressor to compress air or fluid for air conditioning. FIG. 2 also shows a generator 110 connected by a belt so that when the flywheel turns, the generator turns and generates electricity for the vehicle. More particularly, the turning flywheel generates electricity to charge one or more batteries of the vehicle.

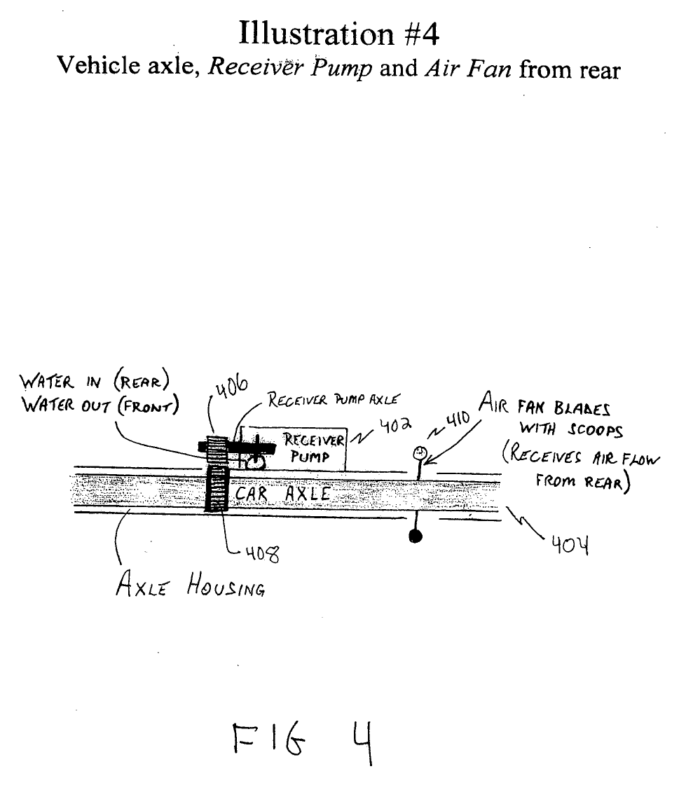

FIG. 4 shows an embodiment of a receiver pump 402 mounted on a vehicle axle 404. Fluid flows through receiver pump 402 from and to fluid pump 108 causing a shaft of receiver pump 402 to turn. Mounted on the shaft to which receiver pump 402 is mounted, is a gear 406. Gear 406 meshes with a gear 408 mounted to turn with axle 404. When receiver pump 402 is caused to rotate by the fluid flowing there through, gear 406 rotates, causing gear 408 and car axle 404 to also rotate. Thus, power from the air that is captured by flywheel 106 is delivered to the axle to drive the vehicle. Also, or in the alternative, air ejected from flywheel 106 may be channeled to air-capturing blades or cups 410 mounted to axle 404 to drive the axle 404.

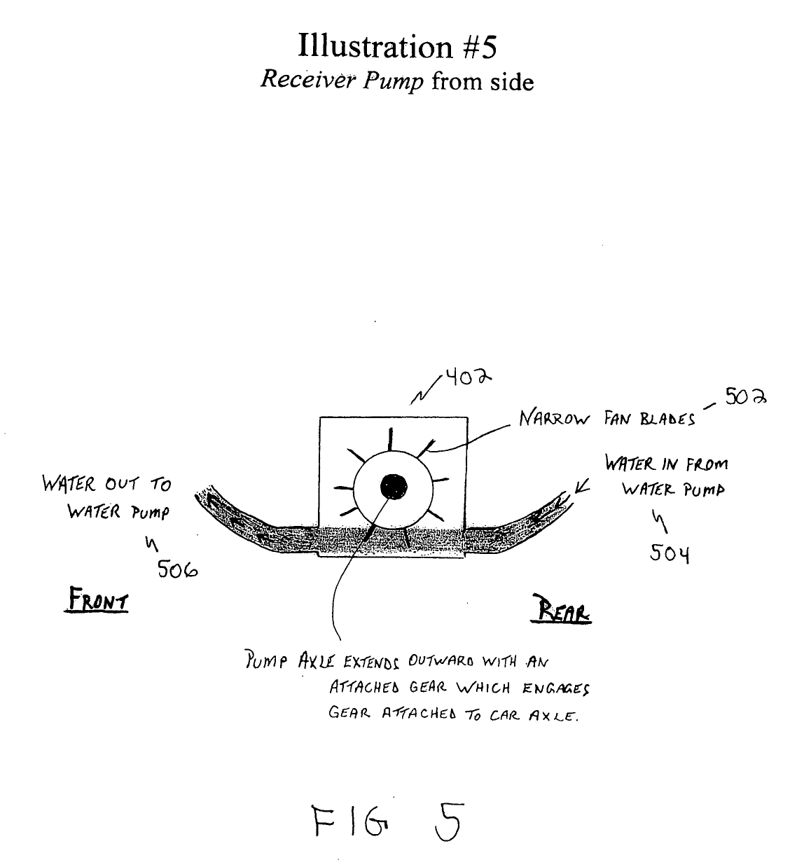

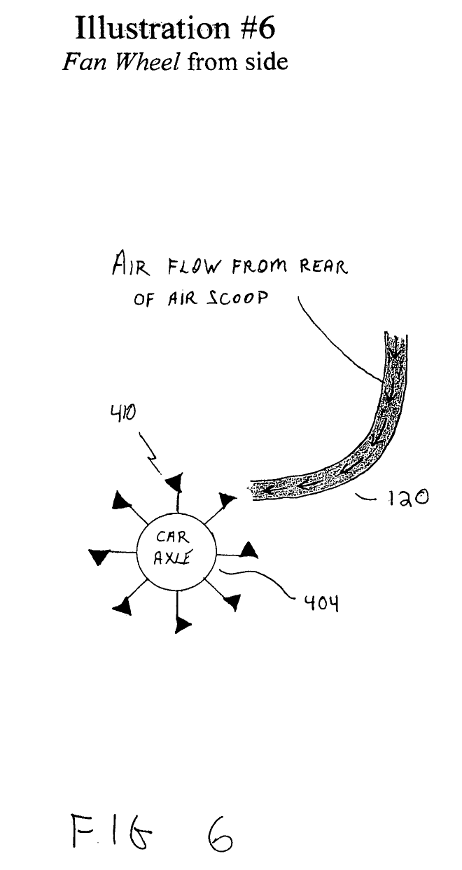

FIG. 5 shows a side view of receiver pump 402. Fluid flows into an inlet 504 passed fan blades 502 to an outlet 506. Inlet 504 passes fluid, which may be under considerable pressure, from fluid pump 108, and outlet 506 passes fluid back to fluid pump 108. Thus, in an embodiment, receiver pump 402 transfers fluid power to rotational power of the axle or shaft of the vehicle. Alternatively, or in addition, a receiver pump may comprise a fluid compressor to compress fluid in an air conditioning system of the vehicle. FIG. 6 shows an end view of air-flow capturing cups 410 mounted concentrically with axle 404. Air is received through channel 120 from the air ejected from flywheel 106. Thus, in one embodiment air-capturing devices form an air fan to capture air to drive a shaft of the vehicle. In another embodiment, air ejected from the flywheel may be used to pump air through an air vent system of the vehicle.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for using wind power to supplement the power of a moving vehicle engine, comprising:
an air scoop for capturing wind flowing passed the vehicle;
a flywheel to capture air in the air scoop causing rotation of the flywheel;
a fluid pump that rotates by rotation of the flywheel and pumps fluid;
a receiver pump to receive fluid pumped by the fluid pump, the received fluid channeled to rotate the receiver pump;
a connecting mechanism connected to a shaft of the vehicle and connected to the receiver pump to transfer rotation of the receiver pump to rotation of the shaft.

2. The apparatus of claim 1, further comprising an electric generator that rotates by rotation of the flywheel and to generate electricity to the vehicle.

3. The apparatus of claim 1, further comprising air-capturing devices to capture air ejected from the flywheel and to transfer energy of the ejected air to drive a shaft of the vehicle.

4. The apparatus of claim 1, wherein the fluid is hydraulic fluid.

5. The apparatus of claim 1, wherein the fluid pump is a fluid compressor in an air conditioning system of the vehicle.

6. The apparatus of claim 1, wherein the receiver pump is a fluid compressor in an air conditioning system of the vehicle.

7. A method for supplementing the power of an engine of a moving vehicle, comprising:
converting air passing the vehicle from linear to rotational power;
applying the rotational power to a fluid pump to pump fluid;
applying the pumped fluid to a receiver pump to create a rotational force; and
applying the rotational force to drive the vehicle.

8. The method of claim 1, further comprising applying the rotational power to an electric generator to generate electricity to the vehicle.

9. The method of claim 7, further comprising applying wind to a fan blade to drive a shaft of the vehicle.

10. The method of claim 7, wherein the fluid is water.

11. The method of claim 7, wherein the fluid pump is a fluid compressor in an air conditioning system of the vehicle.

12. The method of claim 7, wherein the receiver pump is a fluid compressor in an air conditioning system of the vehicle.

13. A wind-powered vehicle, comprising:
an engine to provide a principle source of power to the vehicle;
an air capturing mechanism to convert wind power to rotational power of a first shaft;
a fluid pump attached to rotate by rotation of the first shaft;
a receiver pump to receive fluid pumped by the fluid pump and to rotate in response thereto; and
a second shaft that rotates by rotation of the receiver pump.

14. The vehicle of claim 13, further comprising an electric generator to receive rotational power from the first shaft to provide electrical energy to the vehicle.

15. The vehicle of claim 14, wherein the electrical energy is provided to one or more batteries.

16. The vehicle of claim 13, further comprising an air fan to receive air passing through the air capturing mechanism and to convert the received air to rotational motion of a shaft of the vehicle.

17. The vehicle of claim 17, wherein the shaft of the vehicle is a rear axle of the vehicle.

18. The vehicle of claim 13, wherein the second shaft is a rear axle of the vehicle.

19. The vehicle of claim 13, wherein the fluid pump is a fluid compressor in an air conditioning system of the vehicle.

20. The vehicle of claim 13, wherein the receiver pump is a fluid compressor in an air conditioning system of the vehicle.
